(19) United States
(12) Patent Application Publication
(10) Pub. No.: US 2023/0041501 A1
(43) Pub. Date: Feb. 9, 2023

(54) POLICY NEURAL NETWORK TRAINING USING A PRIVILEGED EXPERT POLICY

(71) Applicant: Waymo LLC, Mountain View, CA (US)

(72) Inventors: David Joseph Weiss, Wayne, PA (US); Jeffrey Ling, Brooklyn, NY (US); Adam Edward Bloniarz, Lafayette, CO (US); Cole Gulino, Pittsburgh, PA (US)

(21) Appl. No.: 17/396,560

(22) Filed: Aug. 6, 2021

(51) Int. Cl. G06N 3/08; G06K 9/00; G06T 7/20

(52) U.S. Cl. CPC G06N 3/08; G06K 9/00624; G06T 7/20; G06T 2207/30241; G06T 2207/20084; G06T 2207/20081

(57) ABSTRACT

Methods, systems, and apparatus, including computer programs encoded on a computer storage medium, for training a policy neural network. In one aspect, a method for training a policy neural network configured to receive a scene data input and to generate a policy output to be followed by a target agent comprises: maintaining a set of training data, the set of training data comprising (i) training scene inputs and (ii) respective target policy outputs; at each training iteration: generating additional training scene inputs; generating a respective target policy output for each additional training scene input using a trained expert policy neural network that has been trained to receive an expert scene data input comprising (i) data characterizing the current scene and (ii) data characterizing a future state of the target agent; updating the set of training data; and training the policy neural network on the updated set of training data.

### BACKGROUND

This specification relates to training a policy neural network that is configured to generate a policy output for a target agent in an environment.

The environment may be a real-world environment, and the target agent can be, e.g., an autonomous vehicle in the environment.

Autonomous vehicles include self-driving cars, boats, and aircraft. Autonomous vehicles use a variety of on-board sensors and computer systems to detect nearby objects and use such detections to make control and navigation decisions.

Some autonomous vehicles have on-board computer systems that implement neural networks, other types of machine learning models, or both for various planning tasks, e.g., object classification within images or route planning. For example, a neural network can be used to determine that an image captured by an on-board camera is likely to be an image of a nearby car. Neural networks, or for brevity, networks, are machine learning models that employ multiple layers of operations to generate one or more outputs from one or more inputs. Neural networks typically include one or more hidden layers situated between an input layer and an output layer. The output of each layer is used as input to another layer in the network, e.g., the next hidden layer or the output layer.

Each layer of a neural network specifies one or more transformation operations to be performed on input to the layer. Some neural network layers have operations that are referred to as neurons. Each neuron receives one or more inputs and generates an output that is received by another neural network layer. Often, each neuron receives inputs from other neurons, and each neuron provides an output to one or more other neurons.

An architecture of a neural network specifies what layers are included in the network and their properties, as well as how the neurons of each layer of the network are connected. In other words, the architecture specifies which layers provide their output as input to which other layers and how the output is provided.

The transformation operations of each layer are performed by computers having installed software modules that implement the transformation operations. Thus, a layer being described as performing operations means that the computers implementing the transformation operations of the layer perform the operations.

Each layer generates one or more outputs using the current values of a set of parameters for the layer. Training the neural network thus involves continually performing a forward pass on the input, computing gradient values, and updating the current values for the set of parameters for each layer using the computed gradient values, e.g., using gradient descent. Once a neural network is trained, the final set of parameter values can be used to make planning outputs in a production system.

### SUMMARY

This specification describes a system implemented as computer programs on one or more computers in one or more locations that trains a policy neural network that is configured to generate a policy output for controlling a target agent in an environment after a current time point.

According to a first aspect there is provided a method performed by one or more computers and for training a policy neural network that is configured to receive a scene data input comprising data characterizing a scene in an environment being navigated through by a target agent at a current time point and to generate a policy output that specifies a future trajectory to be followed by the target agent after the current time point, the method comprising: maintaining a set of training data, the set of training data comprising (i) a plurality of training scene inputs and (ii) for each training scene input, a respective target policy output; at each of one or more of training iterations: generating additional training scene inputs for the training iteration; generating a respective target policy output for each additional training scene input by processing the additional training scene input using a trained expert policy neural network, wherein the trained expert policy neural network is a neural network that has been trained to receive an expert scene data input comprising (i) data characterizing the scene in the environment at the current time point and (ii) data characterizing a future state of the target agent after the current time point and to generate an expert policy output that specifies an expert future trajectory to be followed by the target agent that causes the target agent to reach the future state characterized in the expert scene data input; updating the set of training data to include the additional training scene inputs and the respective target policy outputs for each of the additional training scene inputs; and after the updating, training the policy neural network on the set of training data.

In some implementations, generating additional training scene inputs for the training iteration comprises: controlling the target agent as the target agent navigates through the environment to follow trajectories generated using policy outputs generated by the trained policy neural network after the preceding iteration and expert policy outputs generated by the trained expert policy neural network.

In some implementations, controlling the target agent as the target agent navigates through the environment to follow trajectories generated using policy outputs generated by the trained policy neural network after the preceding iteration and expert policy outputs generated by the trained expert policy neural network comprises: obtaining data from the current set of training data including a trajectory generated by an agent other than the target agent; conditioning the expert policy neural network on a future state of the other agent in the trajectory of the other agent after the first time point; and controlling the target agent starting from the initial state of the other agent trajectory to generate a new trajectory.

In some implementations, controlling the target agent starting from the initial state of the other agent trajectory to generate a new trajectory comprises: obtaining a probability βᵢ corresponding to the current training iteration; and at each of a plurality of control iterations: with probability βᵢ: controlling the target agent as the target agent navigates through the environment to follow a particular expert future trajectory generated using the expert policy output generated by the trained expert policy neural network; or with complementary probability 1-βᵢ: controlling the target agent as the target agent navigates through the environment to follow a particular future trajectory generated using the policy output generated by the trained policy neural network after the preceding iteration.

In some implementations, the method further comprises, before any of the one or more training iterations, training the trained expert policy neural network using data characterizing expert trajectories generated by agents other than the target agent.

In some implementations, updating the set of training data to include the additional training scene inputs and the respective target policy outputs for each of the additional training scene inputs comprises: filtering the additional training scene inputs and the respective target policy outputs for each of the additional training scene inputs in accordance with a set of criteria to remove any respective target policy outputs that violate the set of criteria.

In some implementations, the set of criteria comprises (i) one or more criteria corresponding to traffic laws applicable to the training scene input, and (ii) one or more criteria corresponding to safety regulations applicable to the training scene input.

In some implementations, the target agent is a vehicle in the real-world or a vehicle in a simulation.

In some implementations, the data characterizing a future state of the vehicle after the current time point comprises the pose of the vehicle at a future time point.

In some implementations, data characterizing a future state of the vehicle after the current time point comprises data characterizing perception information about the environment.

In some implementations, the initial set of training data comprises trajectories generated by one or more agents other than the target agent.

In some implementations, the first set of addition training scene inputs is generated based on only the trained expert policy neural network.

In some implementations, the method further comprises, after performing the one or more training iterations, outputting the trained policy neural network after one of the training iterations as a final policy neural network for use in controlling the agent.

In some implementations, outputting the trained policy neural network after one of the training iterations as a final policy neural network for use in controlling the target agent comprises: for the one or more training iterations, measuring a performance of the trained policy neural network after the training iteration; and selecting, as the final policy neural network, the trained policy neural network having a best performance.

Particular embodiments of the subject matter described in this specification can be implemented so as to realize one or more of the following advantages.

The system described in this specification can train a policy neural network that is configured to generate a policy output for controlling a target agent in an environment using a trained expert policy neural network. The system can be configured to train the policy neural network using a set of training data, and, at each training iteration, to generate additional training data to add to the current set of training data, the additional training data including (1) additional training scene inputs, and (2) a respective target policy output for each additional training scene input. The system can generate the additional training scene inputs by, at each of multiple control iterations, controlling a target agent using the trained policy neural network after the previous training iteration to generate “exploration” scene inputs and the expert policy to generate “on-target” scene inputs. The system can stochastically select between the two policies at each control iteration to intertwine additional “exploration” and “on-target” scene inputs to generate additional mixed training data. Then system can then process each additional scene input to generate a respective target policy output for the additional scene input using the trained expert policy neural network. The system can then include the additional training data in the current set of training data, and update the current values of the policy neural network parameters using the new set of training data. Training the policy neural network using mixed training data can enable a more robust performance from the trained policy neural network in situations which deviate from the trained expert policy. That is, training the policy neural network using the mixed training data (e.g., rather than on “on-target” data alone) enables the policy neural network to be trained more quickly (e.g., over fewer training iterations) and achieve better performance (e.g., by enabling the target agent to navigate more effectively). By training the policy neural network more quickly, the training system can consume fewer computational resources (e.g., memory and computing power) during training than some conventional training systems.

The training system described in this specification can train the policy neural network using a trained expert policy neural network with access to privileged information. Before any training iteration for the trained policy neural network, the system can train the expert policy neural network to receive an expert scene data input that includes (i) data characterizing the scene in the environment at the current time point and (ii) data characterizing a future state of the target agent after the current time point. The expert scene data can include privileged data generated from agents other than the target agent, such as from manually driven cars or simulations of other vehicles. During training, for each additional scene input, the system can condition the trained expert policy neural network on an expert scene data input corresponding to the additional scene input, in order to generate the respective target policy output. Training the policy neural network using a trained expert policy neural network with access to privileged data (that is, data characterizing a future state of the target agent) can enable a degree of controllability over the behavior of the policy neural network. The privileged expert policy has access to information concerning an intended future state of the target agent, and can process the intended future state to generate a highly accurate (e.g., compared with a conventional expert without access to privileged information) target policy output for the trained policy neural network to imitate. Conditioning the expert policy neural network on privileged information can enable the expert policy neural network to generate accurate target policy outputs for scene inputs that deviate from the scene data on which it was trained. That is, the expert policy neural network can generate “recovery” target policy outputs to bring the policy neural network back to the trajectory it's imitating even when the additional scene inputs deviate significantly from the original trajectory. Using a privileged expert policy neural network to generate the target policy output for a respective scene input can enable better performance (e.g., by enabling the target agent to navigate more effectively) than some conventional training systems.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example training system.

FIG. 2 is a flow diagram of an example process for training a policy neural network using a trained expert policy neural network.

FIG. 3 is a flow diagram of an example process for generating additional training scene inputs.

Like reference numbers and designations in the various drawings indicate like elements.

### DETAILED DESCRIPTION

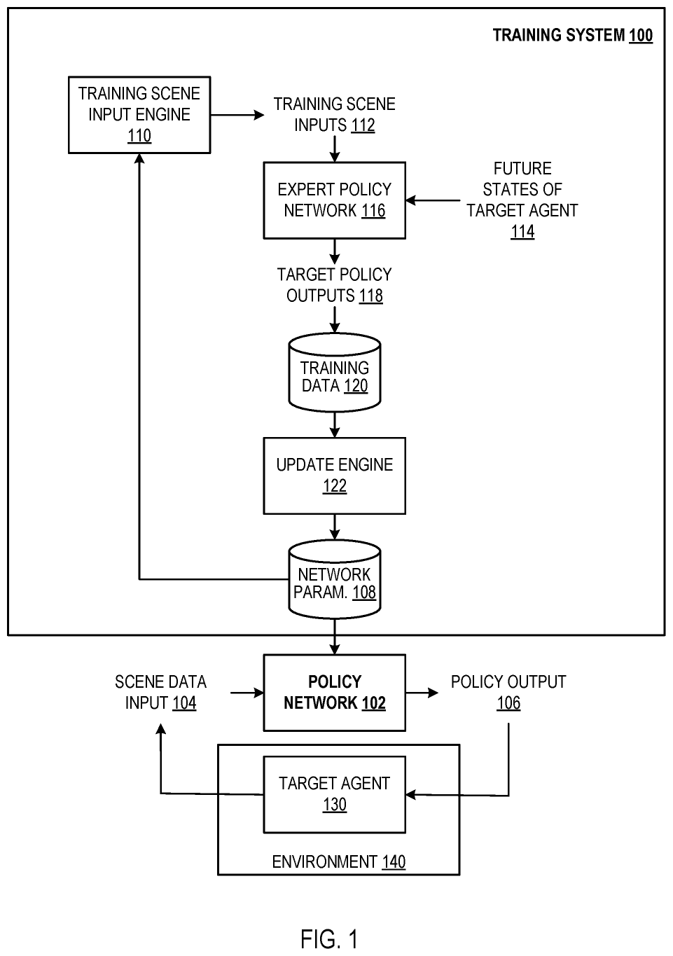

FIG. 1 shows an example training system 100. The training system 100 is an example of a system implemented as computer programs on one or more computers in one or more locations in which the systems, components, and techniques described below are implemented.

The training system 100 trains a policy neural network 102 to generate a policy output (e.g., policy output 106) for controlling a target agent 130 in an environment 140 after a current time point by processing a scene data input characterizing the environment (e.g., scene data input 104) at the current time point. The training system 100 trains the policy neural network by updating a set of network parameters 108 of the policy neural network 102 at each of one or more training iterations, as is described in further detailed below. In one example, the training system 100 can perform a single training iteration, then output the trained policy neural network 102 with network parameters 108 after the single training iteration.

In some implementations, the environment is a real-world environment and the target agent is an autonomous vehicle navigating the real-world environment. For example, the autonomous vehicle can be a fully autonomous or semi-autonomous land, air, or sea vehicle navigating through the environment to a specified destination in the environment.

In these implementations, the training scene inputs can include, for example, one or more of images, object position data, and sensor data to capture scene data as the target agent navigates the environment, e.g., sensor data from a camera or LIDAR sensor.

In these implementations, the policy output for controlling the vehicle can specify an action for controlling the agent, e.g., a steering angle (e.g., relative to the heading of the vehicle) and an acceleration (e.g., to speed or slow the vehicle). For example, each policy output can be a probability distribution over possible actions or can directly regress an action to be performed by the agent.

In some implementations the environment is a simulated environment and the target agent is implemented as one or more computers interacting with the simulated environment.

For example, the simulated environment can be a simulation of a vehicle and the policy neural network can be trained on the simulation. For example, the simulated environment can be a motion simulation environment, e.g., a driving simulation or a flight simulation, and the agent can be a simulated vehicle navigating through the motion simulation. In these implementations, the actions can be control inputs to control the simulated user or simulated vehicle.

Generally in the case of a simulated environment the observations can include simulated versions of one or more of the previously described training scene inputs or types of training scene inputs and the actions can include simulated versions of one or more of the previously described actions or types of actions.

Training an agent in a simulated environment can enable the agent to learn from large amounts of simulated training data while avoiding risks associated with the training the agent in a real world environment, e.g., damage to the agent due to performing poorly chosen actions. An agent trained in a simulated environment can thereafter be deployed in a real-world environment. That is, the policy neural network 102 can be trained on training scene inputs representing an agent navigating a simulated environment. After being trained on training scene inputs representing an agent navigating the simulated environment, the policy neural network 102 can be used to control a real-world agent navigating a real-world environment.

The training system 100 maintains a set of training data, e.g., training data 120, to train the policy network 102. The training data 120 includes (1) multiple training scene inputs, and (2) for each training scene input, a respective target policy output. For example, the initial training data can include trajectories generated by one or more other agents, e.g., manually driven vehicles, or simulated vehicles, or a combination of the two.

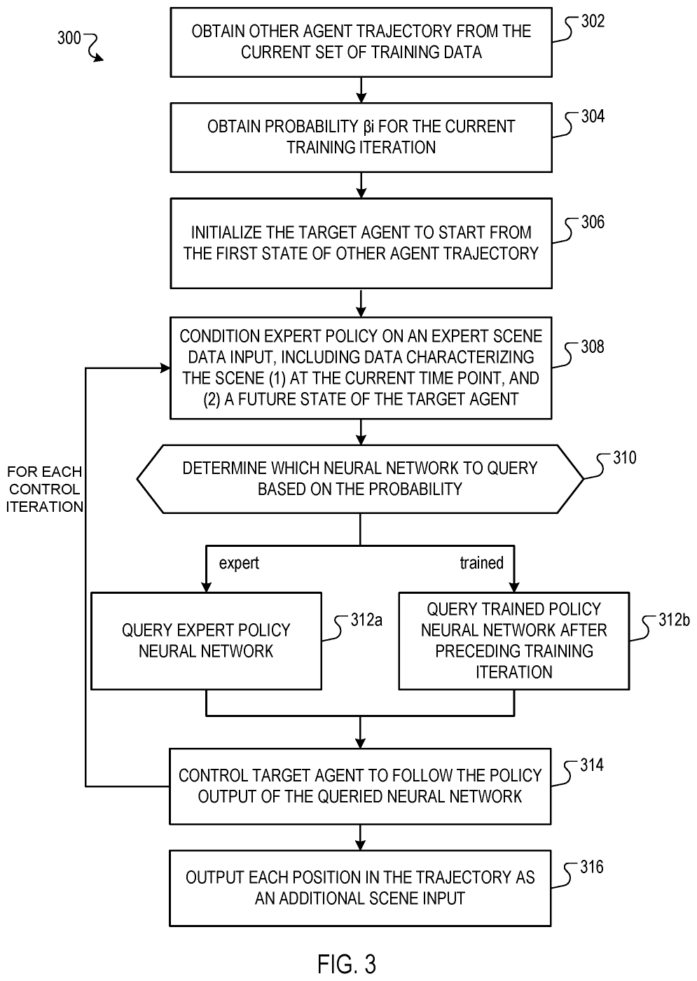

At each training iteration, a training scene input engine 110 generates additional training scene inputs 112. The training scene input engine 110 can generate the additional training scene inputs 112 by processing trajectories generated by other agents from the initial set of training data. For example, the training scene input engine 110 can sample other agent trajectories, then control the target agent 130 at each of multiple control iterations to generate new trajectories beginning from the initial states of the other agent trajectories, as is discussed in further detail with reference to FIG. 3.

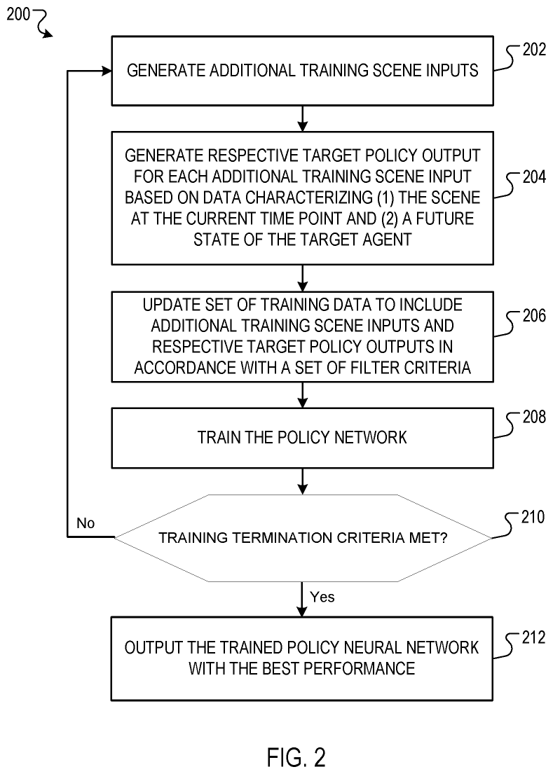

At each training iteration, an expert policy network 116 generates target policy outputs 118 for the training scene inputs 112. The expert policy network 116 can be conditioned on a respective future state of the target agent 130 from the future states of the target agent 114 to generate a respective target policy output for each training scene input. For example, the future state can be from the sampled trajectory processed to generate the training scene input. That is, the future state of the target agent can be a future state of the other agent in the sampled trajectory after the initial time point. The future state of the target agent can include the position, velocity, acceleration, or other information characterizing the state of the target agent at a future time point after the current time point. The expert policy neural network 116 can generate the respective target policy output for a training scene input after being conditioned on the corresponding future state, as is discussed in further detail with respect to FIG. 2.

Before any of the one or more training iterations, the trained expert policy neural network can be trained using data characterizing expert trajectories generated by agents other than the target agent. The trained expert policy neural network can be trained to generate an expert policy output by processing a current state of the target agent after being conditioned on an expert scene data input including data characterizing the scene in the environment at the current time point and a future state of the target agent. The trained expert policy neural network can be trained using any appropriate imitation learning technique, e.g., a behavior cloning technique, an adversarial imitation learning technique, or a DAgger (data aggregation) imitation learning technique.

At each training iteration, the system filters the training scene inputs 112 and respective target policy outputs 118 in accordance with a set of criteria, then updates the training data 120 to include the filtered additional training data. For example, the system can filter the training scene inputs 112 and respective target policy outputs 118 to remove any additional training data that violates a set of traffic laws and a set of safety regulations applicable to the training scene data. In some implementations, the traffic laws and safety regulations can include the target agent 130 exceeding a speed limit, colliding with another agent, deviating beyond a predefined threshold from a particular path, etc.

At each training iteration, an update engine 122 processes the updated training data 120 to train the values of the network parameters 108. The update engine 122 can train the values of the network parameters 108 using a gradient of an objective function in accordance with any appropriate method. In some implementations, the system can maintain a current set of neural network parameters (e.g., network parameters 108) that it updates at each training iteration, while keeping a record of the set of neural network parameters after each training iteration. In some implementations, the system can train a new set of neural network parameters at each training iteration, and keep a record of each set of trained neural network parameters after the respective training iteration. For example, the update engine 122 can generate a gradient of an objective function that measures an error between the target policy outputs and the corresponding policy outputs generated by the policy network 102, then train the policy network parameter values using stochastic gradient descent with or without moment, or ADAM.

After the final training iteration, the training system can evaluate the policy network 102 after each training iteration by measuring a performance for the policy network for controlling the target agent 130 to successfully navigate the environment 140. The system can select and output the particular policy network with the highest performance metric. In some implementations, the performance metric can include how well the policy performs in controlling a simulated agent according to a cost function that measures, e.g., a percentage of successful navigations of the environment resulting from the policy output generated by the particular policy neural, a deviation from a target path for navigating the environment, and a percentage of policy outputs which successfully pass the set of filters. In another example, the cost function can measure how well the policy network performs in imitating an expert agent, e.g., as measured by the error between the policy outputs generated by the policy network and the ground-truth trajectories in a validation set of expert trajectories. In some implementations, the training system can output the trained policy network from the final training iteration (e.g., the training iteration with the largest training data set 120).

Using the selected policy neural network with the best performance, the system can use the policy network 102 to control the target agent 130 in the environment 140. In some implementations, the target agent can be an autonomous vehicle navigating a real-world environment, and the policy network 102 can be deployed on-board the autonomous vehicle. The scene data input 104 can be, e.g., sensor data input characterizing the environment surrounding the autonomous vehicle (e.g., LIDAR sensor data, image data represented by intensity or RGB values for each pixel in the image, object position data for one or more objects in the environment, and agent data characterizing position and velocity for one or more other agents in the environment). The policy neural network 102 can process the scene data input 104 to generate a policy output 106 for controlling the target agent in the environment (e.g., including a steering angle and an acceleration relative to the current velocity of the autonomous vehicle).

FIG. 2 is a flow diagram of an example process for training a policy neural network using a trained expert policy neural network. For convenience, the process 200 will be described as being performed by a system of one or more computers located in one or more locations. For example, a training system, e.g., the training system 100 of FIG. 1, appropriately programmed in accordance with this specification, can perform the process 200.

The system trains the policy neural network at each of one or more training iterations. In some implementations, the system can perform multiple training iterations, and output the policy neural network after a preceding training iteration with a best performance, as is described with further detail below. In another example, the system can perform a single training iteration, then output the trained policy neural network after the single training iteration.

At each training iteration, the system generates additional training scene inputs (202). For example, the system can generate additional training scene inputs by sampling trajectories generated by other agents, then controlling the target agent from the initial state in each sampled trajectory to generate a new respective trajectory. The system can control the target agent at each of multiple control iterations by selecting between the trained policy neural network and the expert policy neural network for controlling the target agent, as is discussed in further detail with respect to FIG. 3.

At each training iteration, the system generates a respective target policy output for each additional training scene input based on data characterizing (1) the scene at the current time point, and (2) a future state of the target agent (204).

The system can generate a respective target policy for an additional training scene input by processing the additional training scene input with a trained expert policy conditioned on the future state of the target agent.

For example, the system can generate each additional training scene input by sampling other agent trajectories, and controlling the target agent from the initial state in each sampled trajectory for each of multiple control iterations. Each generated additional training scene input characterizes a scene that occurs in a trajectory that corresponds to a respective other agent trajectory. That is, each additional training scene input in a trajectory generated from the initial state of a particular other agent trajectory corresponds to that particular other agent trajectory. The trained policy neural network can be conditioned using a future state from the other agent trajectory after the current time point of the control iteration as the future state for the target agent. For example, final time point in the other agent trajectory can be the future state of the target agent used to condition the trained expert policy to generate the respective target policy for the training scene input. In some implementations, the future state can include information about the final location at the end of the other trajectory, about the final location N time units (e.g., seconds) after the current time point of the control iteration, or about the final location M space units (e.g., meters, or feet) ahead of the target agent at the current time point of the control iteration. In some implementations, the future state can include data characterizing the velocity, acceleration, or both, of the target agent, or of other agents in the environment. In some implementations, the future state can include semantic information characterizing other agents in the environment, such as tags for the target agent to pass, not pass, or undecided, for one or more other agents.

The trained expert policy neural network can have any appropriate neural network architecture that enables it to perform its described function, i.e., processing a training scene input to generate a respective target policy output after being conditioned on a future state of the target agent. In particular, the trained expert policy can include any appropriate types of neural network layers (e.g., fully-connected layers, attention-layers, convolutional layers, etc.) in any appropriate numbers (e.g., 1 layer, 5 layers, or 25 layers), and connected in any appropriate configuration (e.g., as a linear sequence of layers). In a particular example, the trained expert policy neural network can include a conditioning neural network head to process the future state of the target agent, and a scene input data head to process the scene input data. The two heads can be followed by a final fully-connected layer to process the concatenation of the output of the two heads. The fully-connected layer outputs a set of scores, where each score corresponds to an action in a set of possible actions that the target agent can perform in the environment.

At each training iteration, the system updates the set of training data to include additional training scene inputs and respective target policy outputs in accordance with a set of filter criteria (206). The system can filter the training scene inputs and respective target policy outputs using a set of one or more traffic law criteria and one or more safety regulation criteria. For example, the system can remove any additional training data where the target agent exceeds a speed limit, collides with another agent or object, deviates beyond a predefined threshold from a target path, etc.

At each training iteration, the system trains the policy neural network (208). The system can train the policy neural network by training the values of the policy neural network parameters using a gradient function with any appropriate method. In some implementations, the system can maintain a current set of neural network parameters that it updates at each training iteration, while keeping a record of the set of neural network parameters after each training iteration. In some implementations, the system can train a new set of neural network parameters at each training iteration, while keeping a record of the trained neural network parameters for each training iteration. For example, the system can determine a gradient of an objective function (e.g., including a Kullback-Leibler divergence term, or a squared error loss term) that measures an error between the target policy outputs and the corresponding policy outputs generated by the policy neural network, then update the current policy neural network parameter values using stochastic gradient descent with or without moment, or ADAM.

The policy neural network can have any appropriate neural network architecture that enables it to perform its described function, i.e., processing a scene input to generate a respective policy output for the target agent. In particular, the policy neural network can include any appropriate types of neural network layers (e.g., fully-connected layers, attention-layers, convolutional layers, etc.) in any appropriate numbers (e.g., 1 layer, 5 layers, or 25 layers), and connected in any appropriate configuration (e.g., as a linear sequence of layers). In a particular example, the final neural network layer can be a fully-connected layer that outputs a set of scores, where each score corresponds to an action in a set of possible actions that the target agent can perform in the environment. In another example, the policy neural network can also include a separate “hint” head to process “hint data” characterizing an intended future state of the target agent. The hint data can include, e.g., a high level intended route for the other agent trajectory that is lower resolution (e.g., including fewer positions at lower time resolution) or “weaker” than the expert future state provided to the expert policy neural network. The hint data for the trained policy neural network could be provided by, e.g., a planning system.

At each training iteration, the system determines whether the termination criteria have been met (210). For example, if the system has not yet completed a predetermined number of training iterations, the system can loop back to step 202 to perform another training iteration.

If the system determines that the termination criteria have been met, the system can output the trained policy neural network with the best performance (212). The system measures a performance of the trained policy neural network after each training iteration, and selects the trained policy neural network with the best performance. In some implementations, the system can output the trained neural network policy from the final training iteration (e.g., the training iteration with the largest training data set). The selected trained policy neural network can be deployed to control the target agent, e.g., on-board on an autonomous vehicle for controlling the autonomous vehicle to navigate through a real-world environment. For example, the performance measure can include how often the particular trained policy neural network successfully controls a target agent through an environment (e.g., as a percentage of a number of trials), what percentage of the particular trained neural network's policy outputs had to be filtered, or how much the particular trained policy neural network deviates from a set of target policy outputs (e.g., measured using spatial positions).

FIG. 3 is a flow diagram of an example process for generating additional training scene inputs. For convenience, the process 300 will be described as being performed by a system of one or more computers located in one or more locations. For example, a training scene input engine, e.g., the training scene input engine 110 of FIG. 1, appropriately programmed in accordance with this specification, can perform the process 300.

The system can perform the process 300 for each of multiple other agent trajectories sampled, e.g., during step 202 of FIG. 2.

The system obtains an other agent trajectory from the current set of training data (302). For example, the other agent trajectory can be generated from manually driven vehicles, simulations of vehicles, or any combination thereof, navigating in an environment.

The system obtains a probability βᵢ for the current training iteration (304). In order to generate the new trajectory from the sampled other agent trajectory, the system controls the target agent at each of multiple control iterations by selecting between the expert policy neural network and the trained policy neural network for controlling the target agent at the current control iteration. The probability βᵢ can correspond to selecting the trained expert policy neural network at each of the multiple control iterations. In some implementations, the probability of selecting the expert policy during the first training iteration can be one to speed initial training of the trained policy neural network, and can relax the probability away from one as a function of the current training iteration (e.g., as a decay) to allow the trained policy neural network after the previous training iteration to generate more “exploration” scene data inputs in later training iterations.

The system initializes the target agent to start from the first state of the other agent trajectory (306). The first state of the other agent trajectory can characterize any of variety of situations of interest for training the trained policy neural network. For example, the first state of the other agent trajectory can place the target agent in particular passing scenarios (e.g., passing a double-parked vehicle, or passing with oncoming traffic), or turning scenarios (e.g., unprotected turns into oncoming traffic).

At each control iteration, the system conditions the trained expert policy neural network on an expert scene data input, including data characterizing the scene (1) at the current time point, and (2) a future state of the target agent (308). The system can generate the expert scene data for the current time point of the control iteration and for the future state of the target agent after the current time point of the control iteration from the other agent trajectory. The system processes a future state after the current time point of the control iteration from the other agent trajectory as an intended future state of the target agent. For example, the future state from the other agent trajectory can include semantic information characterizing other agents in the environment (e.g., control information for the target agent for each other agent, such as pass, no pass, or undecided), an intended future pose of the target agent (e.g., an intended position of the target agent), or other control decisions (e.g., turn left, turn right, go straight at particular positions).

Training the policy neural network using a trained expert policy neural network with access to privileged data characterizing a future state of the target agent can enable a degree of controllability over the behavior of the policy neural network. The privileged expert policy has access to information concerning an intended future state of the target agent, and can process the intended future state to generate a target policy output for the trained policy neural network to imitate. Conditioning the expert policy neural network using privileged data characterizing an intended future state of the target agent can enable the expert policy neural network to generate accurate target policies even for situations which deviate from the training scene inputs used to train the expert policy neural network. Using a privileged expert policy to generate the target policy output for a respective scene input can enable better performance (e.g., by enabling the target agent to navigate through an environment more effectively) than some conventional training systems.

At each control iteration, the system determines which neural network to query based on the probability βᵢ (310). For example, the system can stochastically select between the two neural networks using the probability βᵢ. The system can stochastically select between the two policies at each control iteration to intertwine additional “exploration” scene inputs generated by the trained policy neural network and “on-target” scene inputs generated by the trained expert policy neural network. Training the policy neural network using mixed training data can enable a more robust performance from the trained policy neural network in situations which deviate from the expert policy. That is, training the policy neural network using the mixed training data (e.g., rather than on “on-target” data alone) enables the policy neural network to be trained more quickly (e.g., over fewer training iterations) and achieve better performance (e.g., by enabling the target agent to navigate more effectively, particularly in areas which deviate from the “expert” data). By training the policy neural network more quickly, the training system can consume fewer computational resources (e.g., memory and computing power) during training than some conventional training systems.

If the system selects the expert policy neural network, the system queries the expert policy neural network (312a). The system can condition the expert policy neural network on an expert scene data including data characterizing the scene at the current time point as of the control iteration and an intended future state of the target agent, then query the expert policy neural network for an action by processing the current state of the target agent using the conditioned expert policy neural network. For example, the intended future state of the target agent can include passing information corresponding to other agents in the environment (e.g., pass, no pass, undecided), or intended future positions of the target agent.

If the system selects the trained policy neural network, the system queries the trained policy neural network after the preceding training iteration (312b). The trained policy neural network after the preceding training iteration processes the current state of the target agent to generate a policy output for the target agent at the current time step as of the control iteration. The policy output can be represented by, e.g., a set of numerical values, where each numerical value corresponds to an action in a set of actions that the target agent can perform in the environment.

At each control iteration, the system controls the target agent to follow the policy output of the queried neural network (314). For example, the policy output can include a set of scores, where each score corresponds to an action in a set of possible actions that the target agent can perform in the environment. The set of possible actions that the target agent can perform include adjusting the steering angle (e.g., represented by a degree from the current heading of the target agent) and a magnitude of acceleration for the target agent.

After the system controls the target agent to follow the policy output of the queried neural network, the system determines the state of target agent in the environment. Unless this is the final control iteration, the system performs another control iteration from the determined state of the target agent in the environment. That is, the system loops back to step 308.

After the final control iteration, the system outputs each position in the trajectory as an additional scene input (316). For example, each scene data input can include raw sensor data, a position and velocity of the target agent in the environment, object data characterizing one or more objects (e.g., position and respective state, such as traffic light and crosswalk state), agent data characterizing one or more other agents in the scene (e.g., position, velocity), or any combination thereof.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers and for training a policy neural network that is configured to receive a scene data input comprising data characterizing a scene in an environment being navigated through by a target agent at a current time point and to generate a policy output that specifies a future trajectory to be followed by the target agent after the current time point, the method comprising:
maintaining a set of training data, the set of training data comprising (i) a plurality of training scene inputs and (ii) for each training scene input, a respective target policy output;
at each of one or more of training iterations:
generating additional training scene inputs for the training iteration;
generating a respective target policy output for each additional training scene input by processing the additional training scene input using a trained expert policy neural network, wherein the trained expert policy neural network is a neural network that has been trained to receive an expert scene data input comprising (i) data characterizing the scene in the environment at the current time point and (ii) data characterizing a future state of the target agent after the current time point and to generate an expert policy output that specifies an expert future trajectory to be followed by the target agent that causes the target agent to reach the future state characterized in the expert scene data input;
updating the set of training data to include the additional training scene inputs and the respective target policy outputs for each of the additional training scene inputs; and
after the updating, training the policy neural network on the set of training data.

2. The method of claim 1, wherein generating additional training scene inputs for the training iteration comprises:
controlling the target agent as the target agent navigates through the environment to follow trajectories generated using policy outputs generated by the trained policy neural network after the preceding iteration and expert policy outputs generated by the trained expert policy neural network.

3. The method of claim 2, wherein controlling the target agent as the target agent navigates through the environment to follow trajectories generated using policy outputs generated by the trained policy neural network after the preceding iteration and expert policy outputs generated by the trained expert policy neural network comprises:
obtaining data from the current set of training data including a trajectory generated by an agent other than the target agent;
conditioning the expert policy neural network on a future state of the other agent in the trajectory of the other agent after the first time point; and
controlling the target agent starting from the initial state of the other agent trajectory to generate a new trajectory.

4. The method of claim 3, wherein controlling the target agent starting from the initial state of the other agent trajectory to generate a new trajectory comprises:
obtaining a probability βᵢ corresponding to the current training iteration; and
at each of a plurality of control iterations:
with probability βᵢ:
controlling the target agent as the target agent navigates through the environment to follow a particular expert future trajectory generated using the expert policy output generated by the trained expert policy neural network; or
with complementary probability 1-βᵢ:
controlling the target agent as the target agent navigates through the environment to follow a particular future trajectory generated using the policy output generated by the trained policy neural network after the preceding iteration.

5. The method of claim 1, further comprising, before any of the one or more training iterations, training the trained expert policy neural network using data characterizing expert trajectories generated by agents other than the target agent.

6. The method of claim 1, wherein updating the set of training data to include the additional training scene inputs and the respective target policy outputs for each of the additional training scene inputs comprises:
filtering the additional training scene inputs and the respective target policy outputs for each of the additional training scene inputs in accordance with a set of criteria to remove any respective target policy outputs that violate the set of criteria.

7. The method of claim 6, wherein the set of criteria comprises (i) one or more criteria corresponding to traffic laws applicable to the training scene input, and (ii) one or more criteria corresponding to safety regulations applicable to the training scene input.

8. The method of claim 1, wherein the target agent is a vehicle in the real-world or a vehicle in a simulation.

9. The method of claim 8, wherein the data characterizing a future state of the vehicle after the current time point comprises the pose of the vehicle at a future time point.

10. The method of claim 8, wherein data characterizing a future state of the vehicle after the current time point comprises data characterizing perception information about the environment.

12. The method of claim 1, wherein the initial set of training data comprises trajectories generated by one or more agents other than the target agent.

13. The method of claim 1, wherein the first set of addition training scene inputs is generated based on only the trained expert policy neural network.

14. The method of claim 1, further comprising, after performing the one or more training iterations, outputting the trained policy neural network after one of the training iterations as a final policy neural network for use in controlling the agent.

15. The method of claim 11, wherein outputting the trained policy neural network after one of the training iterations as a final policy neural network for use in controlling the target agent comprises:
for the one or more training iterations, measuring a performance of the trained policy neural network after the training iteration; and
selecting, as the final policy neural network, the trained policy neural network having a best performance.

16. A system comprising:
one or more computers; and
one or more storage devices communicatively coupled to the one or more computers, wherein the one or more storage devices store instructions that, when executed by the one or more computers, cause the one or more computers to perform operations for training a policy neural network that is configured to receive a scene data input comprising data characterizing a scene in an environment being navigated through by a target agent at a current time point and to generate a policy output that specifies a future trajectory to be followed by the target agent after the current time point, the operations comprising:
maintaining a set of training data, the set of training data comprising (i) a plurality of training scene inputs and (ii) for each training scene input, a respective target policy output;
at each of one or more of training iterations:
generating additional training scene inputs for the training iteration;
generating a respective target policy output for each additional training scene input by processing the additional training scene input using a trained expert policy neural network, wherein the trained expert policy neural network is a neural network that has been trained to receive an expert scene data input comprising (i) data characterizing the scene in the environment at the current time point and (ii) data characterizing a future state of the target agent after the current time point and to generate an expert policy output that specifies an expert future trajectory to be followed by the target agent that causes the target agent to reach the future state characterized in the expert scene data input;
updating the set of training data to include the additional training scene inputs and the respective target policy outputs for each of the additional training scene inputs; and
after the updating, training the policy neural network on the set of training data.

17. The system of claim 16, wherein generating additional training scene inputs for the training iteration comprises:
controlling the target agent as the target agent navigates through the environment to follow trajectories generated using policy outputs generated by the trained policy neural network after the preceding iteration and expert policy outputs generated by the trained expert policy neural network.

18. The system of claim 17, wherein controlling the target agent as the target agent navigates through the environment to follow trajectories generated using policy outputs generated by the trained policy neural network after the preceding iteration and expert policy outputs generated by the trained expert policy neural network comprises:
obtaining data from the current set of training data including a trajectory generated by an agent other than the target agent;
conditioning the expert policy neural network on a future state of the other agent in the trajectory of the other agent after the first time point; and
controlling the target agent starting from the initial state of the other agent trajectory to generate a new trajectory.

19. The system of claim 16, further comprising, before any of the one or more training iterations, training the trained expert policy neural network using data characterizing expert trajectories generated by agents other than the target agent.

20. One or more non-transitory computer storage media storing instructions that when executed by one or more computers cause the one or more computers to perform operations for training a policy neural network that is configured to receive a scene data input comprising data characterizing a scene in an environment being navigated through by a target agent at a current time point and to generate a policy output that specifies a future trajectory to be followed by the target agent after the current time point, the operations comprising:
maintaining a set of training data, the set of training data comprising (i) a plurality of training scene inputs and (ii) for each training scene input, a respective target policy output;
at each of one or more of training iterations:
generating additional training scene inputs for the training iteration;
generating a respective target policy output for each additional training scene input by processing the additional training scene input using a trained expert policy neural network, wherein the trained expert policy neural network is a neural network that has been trained to receive an expert scene data input comprising (i) data characterizing the scene in the environment at the current time point and (ii) data characterizing a future state of the target agent after the current time point and to generate an expert policy output that specifies an expert future trajectory to be followed by the target agent that causes the target agent to reach the future state characterized in the expert scene data input;
updating the set of training data to include the additional training scene inputs and the respective target policy outputs for each of the additional training scene inputs; and
after the updating, training the policy neural network on the set of training data.
